(19) United States
(12) Patent Application Publication
(10) Pub. No.: US 2026/0296517 A1
(43) Pub. Date: Oct. 1, 2026

(54) SLIDING MECHANISM AND CART BODY WITH SLIDING MECHANISM

(71) Applicant: New Century Products Co., Ltd., Taipei City (TW)

(72) Inventor: Fu-Tsun Lin, Taipei City (TW)

(21) Appl. No.: 19/097,055

(22) Filed: Apr. 1, 2025

(51) Int. Cl. B62B 9/12; B62B 3/02; B62B 3/14; B62B 7/06; B62B 9/08; B62B 9/10

(52) U.S. Cl. CPC B62B 9/12; B62B 7/062; B62B 9/102; B62B 3/025; B62B 3/14; B62B 9/082

(57) ABSTRACT

The present invention discloses a sliding mechanism, including: a track body and two sliders, where two opposite sides of the track body each have a groove, and each slider is embedded in a corresponding groove. The present invention also discloses a cart body with a sliding mechanism, including: two front wheels; two rear wheels; a lower frame, where two front wheel pivot seats and two rear wheel pivot seats are disposed at corners of the lower frame; a front support rod set with two front support rods and a handle; a rear support rod set, where the rear support rod set has two rear support rods; a pair of latches, respectively disposed on the front support rods; an upper frame, including two support arms on a lower front side; and the sliding mechanism. The sliding mechanism disclosed by the present invention, when applied to a cart body, can adjust the seating or storage space.

### BACKGROUND OF THE INVENTION

### 1. Field of the Invention

The present invention relates to a sliding mechanism and a cart body with a sliding mechanism, particularly to a cart body with a sliding mechanism that can adjust the seating or storage space.

### 2. Description of the Prior Art

Carts are one of the well-known inventions of the 20th century, with a wide range of applications. For example, single strollers, double strollers, shopping carts, camping carts, handcarts, baby strollers, or the like are invented. Baby strollers are undoubtedly one of the important items in parenting life. Whether for daily outings, shopping, or long-distance travel, a suitable baby stroller provides comfortable sitting experience for toddlers and contributes to easy travel of parents.

However, due to the lightweight design of baby strollers, the comfort for the baby during sitting is relatively poor, and the storage space is limited. Conventional baby stroller designs mainly focus on portability, so the storage space is relatively small. If the storage space is increased, the baby stroller is usually heavier and bulkier, making it difficult to operate in narrow spaces.

Babies of different ages require different types of baby strollers. Babies under six months are suitable for lying flat and two-way baby strollers, allowing them to see their parents, and increasing their sense of security. For babies over one year old who cannot sit for a long time, it is most important to adjust the seat angle to make the baby sit comfortably.

### SUMMARY OF THE INVENTION

Therefore, after years of diligent research and combining slides with cart bodies, the inventor has successfully developed the sliding mechanism and the cart body with a sliding mechanism of the present invention.

A main objective of the sliding mechanism and the cart body with a sliding mechanism of the present invention is to provide an adjustable seating space, such that babies of different ages can sit, thereby increasing seating comfort.

Another objective of the sliding mechanism and the cart body with a sliding mechanism of the present invention is to increase the storage space of the cart body to enhance the use functionality.

To achieve the foregoing objectives, the present invention provides a sliding mechanism, including: a sliding mechanism, where the sliding mechanism includes: a track body and two sliders, where the track body is a frame structure, two opposite sides of the track body each have a groove, and each slider is embedded in a corresponding groove, such that each slider slides along the corresponding groove.

The sliding mechanism is applicable to a shopping cart, a baby stroller, an industrial cart, a pet stroller, and a human-pet shared stroller.

The present invention further discloses a cart body with a sliding mechanism, including: a front wheel set, where the front wheel set is disposed in front of the cart body; a rear wheel set, where the rear wheel set is disposed behind the cart body, and the rear wheel set and the front wheel set are respectively disposed on two opposite sides of the cart body; a lower frame, where two front wheel pivot seats and two rear wheel pivot seats are disposed at corners of the lower frame, the front wheel pivot seats are respectively connected to two opposite sides of the front wheel set, the rear wheel pivot seats are respectively connected to two opposite sides of the rear wheel set, and the lower frame is configured for mounting the front wheel set and the rear wheel set; a front support rod set, including two front support rods and a handle, where one end of each front support rod is connected to a respective front wheel pivot seat via a front connector, and two ends of the handle are respectively connected to the other ends of the front support rods extending therefrom; a rear support rod set, including two rear support rods, where each rear support rod is connected to a respective rear wheel pivot seat via a rear connector, the front support rod is connected to the rear support rod via a folding unit, and the folding unit drives the rear support rod to slide along the front support rod; a pair of latches, each disposed at an extending end of a respective front support rod, where the latch latches onto the front connector to fix the front support rod; an upper frame, including two support arms and two protruding shafts on a lower front side, where each support arm is slidably disposed on a respective front support rod via the folding unit, and a rear side of the upper frame is pivotally connected to the front support rods on two sides; and a sliding mechanism, where the sliding mechanism includes: a track body and at least one slider, where the track body is an enclosed frame, with a groove on an inner side, and each slider is embedded in the track body, such that each slider slides along the track body.

Two adjustment knobs are respectively disposed at joints between the front support rods and two ends of the handle.

The rear wheels are provided with a brake pedal, the brake pedal is disposed between the rear wheels, and when the brake pedal is stepped on, braking force is provided to the rear wheels.

The cart body with a sliding mechanism further includes a rotating mechanism, where the rotating mechanism includes: two bases and a canopy frame, where each base is disposed in the middle of two opposite sides of the track body, two ends of the canopy frame are pivotally connected to the bases, respectively, the canopy frame is provided with a canopy, and the canopy fits with the canopy frame to rotate around each base.

The rotating mechanism further includes a ratchet apparatus.

In summary, the cart body with a sliding mechanism of the present invention has the following main advantages:

1. Adjustable seating space allows babies of different ages to sit, and moving the slide can enhance the comfort of the baby during sitting.

2. To improve the prior cart design where a storage space being arranged below results in a narrow seating space, the lower storage space of the cart body with a sliding mechanism is changed to a seating space, providing a spacious design of the cart body.

3. If a tray is to be added to the cart body, the tray can be clipped onto the sliding mechanism, allowing for convenient mounting and disassembly by the user.

### BRIEF DESCRIPTION OF THE DRAWINGS

FIG. 1 is a schematic three-dimensional diagram of a sliding mechanism according to the present invention.

FIG. 2 is a schematic three-dimensional diagram of a cart body with a sliding mechanism according to the present invention.

FIG. 3 is a schematic diagram of the cart body with a sliding mechanism according to a first embodiment of the present invention.

FIG. 4 is another schematic diagram of the cart body with a sliding mechanism according to a first embodiment of the present invention.

FIG. 5 is a schematic diagram of the cart body with a sliding mechanism according to a second embodiment of the present invention.

### DESCRIPTION OF SIGNS OF MAIN COMPONENTS

100: Front wheel set
200: Rear wheel set
210: Brake pedal
300: Lower frame
310: Front wheel pivot seat
320: Rear wheel pivot seat
400: Front support rod set
410: Front support rod
411: Front connector
420: Handle
500: Rear support rod set
510: Rear support rod
511: Rear connector
512: Folding unit
600: Latch
710: Sliding mechanism
711: Track body
712: Slider
713: Groove
720: Rotating mechanism
721: Base
722: Canopy frame
730: Support arm
800: Seat

### DETAILED DESCRIPTION OF THE PREFERRED EMBODIMENT

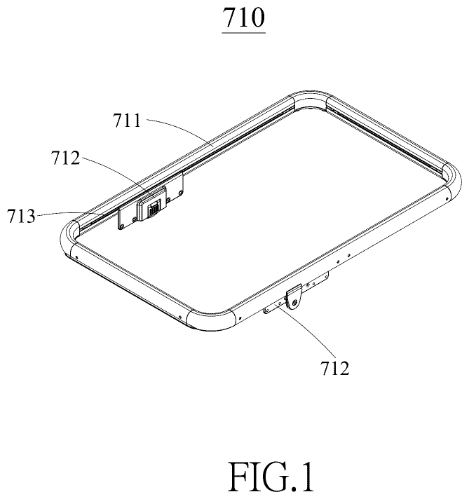

Refer to FIG. 1, which is a schematic three-dimensional diagram of a sliding mechanism 700 according to the present invention. The sliding mechanism 700 is applied to handcarts but is not limited to handcarts.

The sliding mechanism 710 includes: a track body 711 and two sliders 712. The track body 711 is a rectangular frame, and left and right inner sides of the track body 711 have grooves 713. The grooves 713 extend from the front end to the rear end along the left and right sides of the track body 711. Sliders 712 are respectively embedded into the grooves 713 on the left and right sides, and each slider 712 can slide on the track body 711.

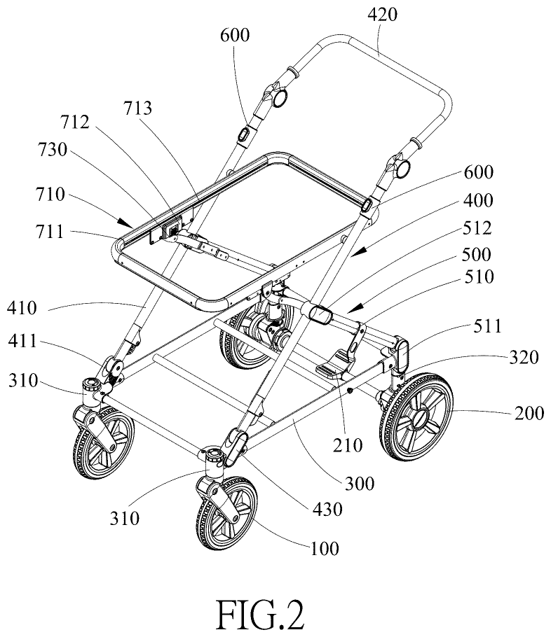

Refer to FIG. 2, which is a schematic three-dimensional diagram of a cart body with a sliding mechanism according to the present invention. The sliding mechanism is not limited to the cart body of this embodiment. The cart body with a sliding mechanism includes: a front wheel set 100, a rear wheel set 200, a lower frame 300, a front support rod set 400, a rear support rod set 500, a pair of latches 600, and a sliding mechanism 700.

The front wheel set 100 and the rear wheel set 200 are respectively disposed on the front side and the rear side of the cart body. The front wheel set 100 and the rear wheel set 200 are the tires of the cart body.

The rear wheel set 200 is provided with a brake pedal 210. The brake pedal 210 is disposed between the rear wheel set 200. When the user steps on the brake pedal 210, the tires of the rear wheel set 200 can be fixed, making the cart body fixed and immovable.

Two front wheel pivot seats 310 and two rear wheel pivot seats 320 are disposed at corners of the lower frame 300, the front wheel pivot seats 310 are respectively connected to two opposite sides of the front wheel set 100, the rear wheel pivot seats 320 are respectively connected to two opposite sides of the rear wheel set 200, and the lower frame 300 is configured for mounting the front wheel set 100 and the rear wheel set 200.

The front support rod set 400 has two front support rods 410 and a handle 420. One end of each front support rod 410 is connected to a respective front wheel pivot seat 310 via a front connector 411, and two ends of the handle 420 are respectively connected to the other ends of the front support rods 410. The height of the handle 420 from the ground is 120-140 cm, approximately at the chest level of an adult, making it convenient for the user to push the handcart.

The rear support rod set 500 has two rear support rods 510. Each rear support rod 510 is connected to a respective rear wheel pivot seat 320 via a rear connector 511. Joints of the two front support rods 410 and the two rear support rods 510 are each provided with a folding unit 512. When the front support rod 410 rotates around the front connector 411 as a center, the front support rod 410 drives, via the folding unit 512, the rear support rod 510 to rotate around the rear connector 511 as the center, allowing the cart body to fold down in a cross manner.

Each latch 600 is disposed at one end of a respective front support rod 410 near the handle 420. The latch 600 is connected to the front connector 411. When the handle 420 is lifted to 120-140 cm from the ground, the latch 600 fixes the front connector 411, making the front support rod 410 and the rear support rod 510 fixed and immovable.

The sliding mechanism 700 includes: two support arms 730, a track body 711, and two sliders 712. Each support arm 730 is pivotally connected to the folding units 512 on the left and right sides, and the left and right sides of the track body 711 are pivotally connected to the front support rods 410 on two sides, respectively, such that when the cart body is folded, the track body 711 can move downward. The track body 711 is a rectangular frame, and the left and right inner sides of the track body 711 have grooves 713. The grooves 713 extend from the front end to the rear end along the left and right sides of the track body 711. Each slider 712 is embedded in a respective groove 713, allowing each slider 712 to slide on the track body 711 based on the user's adjustment.

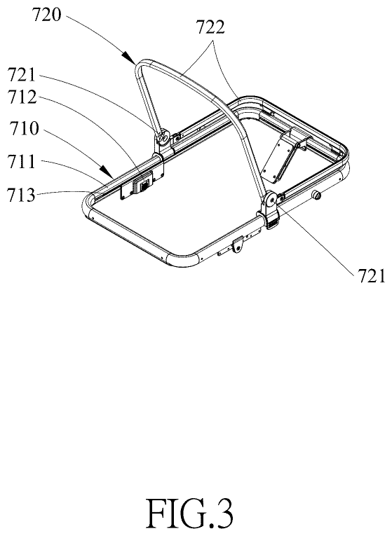

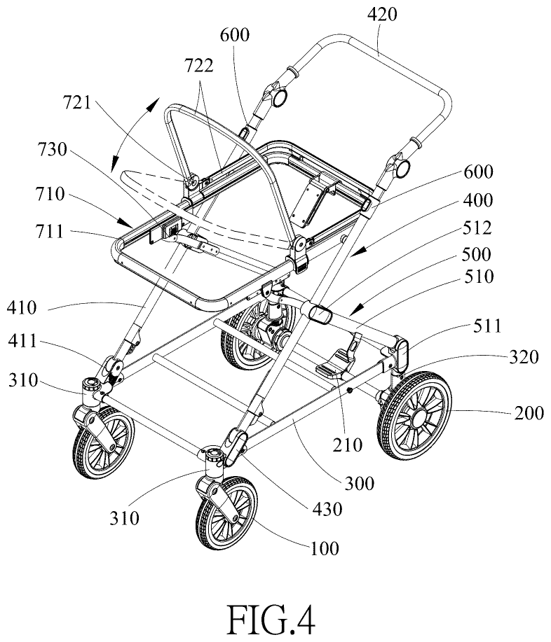

Referring to FIGS. 3 and 4, in a first embodiment, a rotating mechanism 720 is also included. The rotating mechanism 720 includes: two bases 721 and a canopy frame 722. Each base 721 is disposed in the middle of the left and right sides of the track body 711, and two ends of the canopy frame 722 are pivotally connected to the bases 721, respectively. The canopy frame 722 is provided with a canopy (not shown in the figure) to block sunlight. The canopy fits with the canopy frame 722 to rotate around each base 721 and can be unfolded or folded.

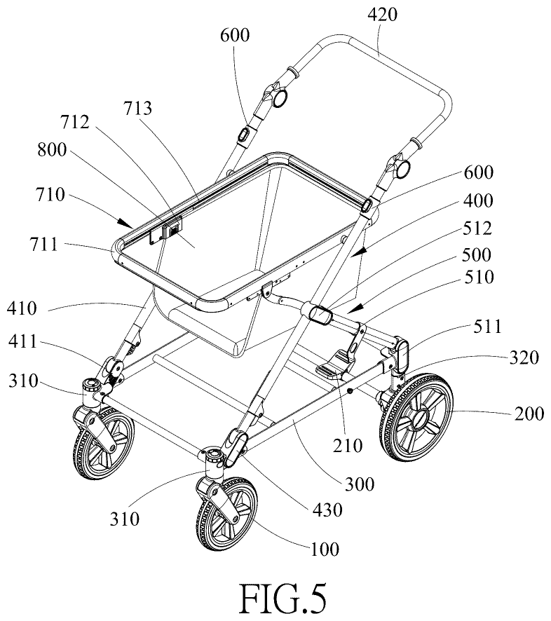

Referring to FIG. 5, in a second embodiment, a seat 800 is also included. Two ends of the seat 800 are connected to the sliders 712. When the sliders 712 move toward the front of the cart body, the seat 800 slides forward, increasing the storage space behind the seat 800. When the sliders 712 move toward the rear of the cart body, the seat 800 slides backward, increasing the seating space.

In another embodiment, the rotating mechanism 720 further includes a ratchet mechanism (not shown in the figure). The ratchet mechanism is configured to adjust and position the canopy frame 722.

In another embodiment, the sliding mechanism 700 further includes a tray (not shown in the figure). Two ends of the tray are clipped onto the sliders 712 on both sides, and the tray provides a space for placing meals.

The above-mentioned embodiments express only some of the embodiments of the present invention but are not intended to limit the patent scope of the present invention, and for those of ordinary skill in the art, a number of variations and improvements derived therefrom without departing from the technical features constructed by the patent scope of the present invention all fall within the scope of protection of the present invention.

What is claimed is:

1. A sliding mechanism, comprising:
a track body and two sliders, wherein the track body is a frame structure, two opposite sides of the track body each have a groove, and each slider is embedded in a corresponding groove, such that each slider slides along the corresponding groove.

2. The sliding mechanism according to claim 1, wherein the sliding mechanism is applicable to a shopping cart, a baby stroller, an industrial cart, a pet stroller, and a human-pet shared stroller.

3. A cart body with a sliding mechanism, comprising:
a front wheel set, wherein the front wheel set is disposed in front of the cart body;
a rear wheel set, wherein the rear wheel set is disposed behind the cart body, and the rear wheel set and the front wheel set are respectively disposed on two opposite sides of the cart body;
a lower frame, wherein two front wheel pivot seats and two rear wheel pivot seats are disposed at corners of the lower frame, the front wheel pivot seats are respectively connected to two opposite sides of the front wheel set, the rear wheel pivot seats are respectively connected to two opposite sides of the rear wheel set, and the lower frame is configured for mounting the front wheel set and the rear wheel set;
a front support rod set, comprising two front support rods and a handle, wherein one end of each front support rod is connected to a respective front wheel pivot seat via a front connector, and two ends of the handle are respectively connected to the other ends of the front support rods extending therefrom;
a rear support rod set, comprising two rear support rods, wherein each rear support rod is connected to a respective rear wheel pivot seat via a rear connector, the front support rod is connected to the rear support rod via a folding unit, and the folding unit drives the rear support rod to slide along the front support rod;
a pair of latches, each disposed at an extending end of a respective front support rod, wherein the latch latches onto the front connector to fix the front support rod;
an upper frame, comprising two support arms and two protruding shafts on a lower front side, wherein each support arm is slidably disposed on a respective front support rod via the folding unit, and a rear side of the upper frame is pivotally connected to the front support rods on two sides; and
a sliding mechanism, wherein the sliding mechanism comprises: a track body and at least one slider, wherein the track body is an enclosed frame, with a groove on an inner side, and each slider is embedded in the track body, such that each slider slides along the track body.

4. The cart body with a sliding mechanism according to claim 3, wherein two adjustment knobs are respectively disposed at joints between the front support rods and two ends of the handle.

5. The cart body with a sliding mechanism according to claim 3, wherein the rear wheels are provided with a brake pedal, the brake pedal is disposed between the rear wheels, and when the brake pedal is stepped on, braking force is provided to the rear wheels.

6. The cart body with a sliding mechanism according to claim 3, further comprising a rotating mechanism, wherein the rotating mechanism comprises: two bases and a canopy frame, wherein each base is disposed in the middle of two opposite sides of the track body, two ends of the canopy frame are pivotally connected to the bases, respectively, and the canopy frame rotates around each base as a center.

7. The cart body with a sliding mechanism according to claim 6, wherein the canopy frame is provided with a canopy, and the canopy fits with the canopy frame to rotate around each base.

8. The cart body with a sliding mechanism according to claim 6, wherein the rotating mechanism further comprises a ratchet apparatus.
